(19) United States
(12) Patent Application Publication
(10) Pub. No.: US 2015/0027047 A1
(43) Pub. Date: Jan. 29, 2015

(54) Plant Shape Template

(71) Applicant: Greg Roberts, Bay Minette, AL (US)

(72) Inventor: Greg Roberts, Bay Minette, AL (US)

(21) Appl. No.: 13/952,401

(22) Filed: Jul. 26, 2013

(51) Int. Cl. A01G 9/02

(52) U.S. Cl. CPC A01G 9/02
USPC 47/66.7; 47/65.5

(57) ABSTRACT

Disclosed herein are devices and related methods for using those devices in the planting and/or placing of plants, flowers, and/or other vegetation in specific and defined shapes. The devices and methods for using those devices are related to carpet bedding, gardens, home gardening, gardening kits, floating plant shapes and designs, and others.

### FIELD OF THE INVENTION

A preferred embodiment of the invention refers to a template and method for creating and planting images, words, or other symbols using flowers and other plants.

### BACKGROUND

The earliest gardens, dating back to ancient Greece, were products of necessity—they provided food and shade. Today, however, decorative gardens are also popular. Carpet bedding is one popular form of decorative gardening. Carpet bedding is a technique that combines colors, tones, and textures of plants in geometric patterns. Public parks and gardens often use carpet bedding to create words and images. While home gardeners would also like to include shapes, letters, and symbols in their gardens, many find carpet bedding prohibitively expensive because it requires artistic skill and labor-intensive upkeep.

Carpet bedding methods have remained the same for many years. Gardeners use stakes and strings to create the desired shape and/or design and then plant within the boundary. Because carpet beds rely on clear and obvious lines to create the sharp edges of the shapes and images, it is important that the shape be routinely pruned and manicured. This constant attention to pruning and maintaining the shape is one primary disadvantage to carpet bedding.

Another major disadvantage to carpet bedding is the sheer artistic talent required to create perfectly symmetrical shapes with plants and/or flowers. For example, creating a design consisting of a triangle inside of a circle inside of a square, with each shape made of different colored flowers, would be a daunting task for all but a professional landscape architect. The high cost of hiring a landscape architect to create and maintain the flower design is cost prohibitive for all but the most affluent individuals. Similarly, creating detailed and manicured shapes for holidays and special occasions is cost and time prohibitive.

There have been attempts to create systems allowing for an end user to create a design in his or her garden as noted in U.S. Pat. No. 8,033,049 and US. Publication No. US20030046866. However, the current state of the art requires significant artistic talent to form and maintain the plant design. Additional artistic talent is required to select the flowers that will have the best contrast to ensure the design is noticeable and distinct. Choosing the correct flowers and plants to place inside the design also requires a firm understanding of various plant and flower species, blooming characteristics, life expectancy, and other similar considerations. The requirements for high-level artistic skill and extensive plant knowledge makes planting flowers and plants in predetermined shapes and designs a cost and skill prohibitive endeavor for most gardeners.

Aside from the time consuming task of manicuring the carpet bed's defined lines, the need for constant removal of weeds is another major disadvantage associated with carpet bedding. The problem is worse when the preformed shape of the plants or flowers is large and a worker cannot reach the middle sections of the preformed shape without walking over and/or disturbing the outsider plants and flowers.

Therefore, a need exists in the art for a preformed template that can be used individually or together with other preformed templates for creating shapes and figures with flowers and plants. The preformed template may include a top and/or bottom section. The bottom section may be equipped with flotation devices for creating floating preformed plant designs. Additionally, there is a need in the art for a simple kit and method using individual dividers and connectors for creating custom carpet bed designs with little time or effort.

Furthermore, a need exists in the art for a preformed template that decreases the number of weeds and unwanted plant growth inside the preformed plant shape. In addition, there is a need in the art for a preformed container, in a certain shape, with bedding material, fertilizer, soil, and seeds already in the preformed container.

As demonstrated, a need exists in the art for a preformed plant template allowing a home gardener to simply and cost-effectively create shapes with plants and flowers.

### SUMMARY

The present invention is directed to a preformed template for planting flowers and plants in predetermined designs. A version of the present invention is made up of a preformed template. The template can be made of natural or synthetic material. In one embodiment, the template is made of a polymer or plastic. In another, the template is made of aluminum, steel, or other metal material. In one embodiment, the plant shape template has sides with no top or bottom section. In another embodiment, the plant shape template includes a bottom section. In yet another embodiment, the plant shape template includes a bottom and top section. In yet another embodiment, the plant shape template includes flotation devices on the bottom of said plant shape template.

A version of the invention includes the plant shape template being used in a preformed kit. The preformed kit is comprised of the preformed plant shape template, soil in said template, and predetermined seeds planted in said soil. In another embodiment, the preformed kit includes preplanted flowers or plants, ready for displaying in the garden. In yet another embodiment, the preformed kit includes preplanted flowers or plants that are more mature than a seedling, yet not fully blooming.

Using a version of the invention, a home gardener is able to easily and cost-effectively create highly defined and well-manicured gardens. It is understood that a gardener may use only one preformed template, or more than one preformed template, in his or her garden. Is is further understood that a gardener may create custom templates with dividers and divider connectors.

The gardener, using only one plant form template, may center the shape in the middle of the garden, and surround the plant form template with additional plants and flowers of his or her choosing. This approach will allow the gardener to display a well-defined shape in his or her garden without spending a great deal of time and money on manicuring the sharp edges. Because the plant form template will confine the plants, the amount of manicuring needed to maintain sharp and defined lines will be greatly reduced.

Gardeners may also use more than one plant form template. Additionally, gardeners may use at least one plant form template and dividers and dividers connectors to create a custom design. Alternatively, gardeners may use only dividers and divider connectors. For example, a gardener may use a circle plant form template, dividers, and dividers connectors. Using these separate templates, dividers, and divider connectors, the gardener can create a complex design with an appearance of a triangle inside of a circle and the circle inside of a square. Creating a well-defined, multi-colored carpet bed would be as simple as inserting the three separate colors into the three separate shapes. A further advancement with using a version of the invention is that the gardener can periodically reconfigure the shapes to create new designs.

Additionally, a gardener may use separate dividers and divider templates to create a custom shape. Once the custom shape is created, the gardener may place plants directly into the custom shape template. If desired, the custom plant template can be used in conjunction with a preformed plant template.

One version of the invention is used to display plants in a shape, letter, or word in a standing body of water, such as a pool, pond, or lake. In one embodiment, using a plant form template with flotation devices attached thereto creates the floating version of the invention.

Yet another version of the invention is used to decrease or eliminate weeds or other unwanted plants inside the plant form template. The version of the invention, in one embodiment, includes a bottom section that is impenetrable to weeds and other plants growing below the bottom of the plant form template.

A preferred version of the invention has anchor means attached to the plant form template and dividers for securing the template and designs to the ground, or some other support.

### DESCRIPTION OF THE DRAWINGS

These and other features, aspects, and advantages of the present invention will become better understood with regard to the following description, appended claims, and accompanying drawings where:

FIG. 1 is a top view of a version of an apparatus embodying features of the present invention for planting shapes and designs;

FIG. 2 is a perspective view of a version of an apparatus embodying features of the present invention for planting shapes and designs;

FIG. 3 is a perspective view of another version of an apparatus embodying features of the present invention for planting shapes and designs;

FIG. 4 is a top view of another version of an apparatus embodying features of the present invention for planting shapes and designs;

FIG. 5 is a perspective view of another version of an apparatus embodying features of the present invention for planting shapes and designs;

FIG. 6 is a top view of another version of an apparatus embodying features of the present invention for planting shapes and designs;

FIG. 7 is a perspective view of another version of an apparatus embodying features of the present invention for planting shapes and designs;

FIG. 8 is a perspective view of another version of an apparatus embodying features of the present invention for planting shapes and designs;

FIG. 9 is a perspective view of another version of an apparatus embodying features of the present invention for planting shapes and designs;

FIG. 10 is a perspective view of another version of an apparatus embodying features of the present invention for planting shapes and designs;

FIG. 11 is a top view of another version of an apparatus embodying features of the present invention for planting shapes and designs; and

FIG. 12 is a perspective view of another version of an apparatus embodying features of the present invention for planting shapes and designs.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, and article “comprising” components A,B, and C can contain only components A, B, and C, or can contain not only components A, B, and C, but also one or more other components.

The terms “shapes” and “designs” and grammatical equivalents, when used in the context with a plant form template, comprise all configurations including, but not limited to, shapes, designs, letters, words, numbers, abstract designs, animals, people, holiday shapes, toys, and other configurations.

Where reference is made herein to a method comprising two ore more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

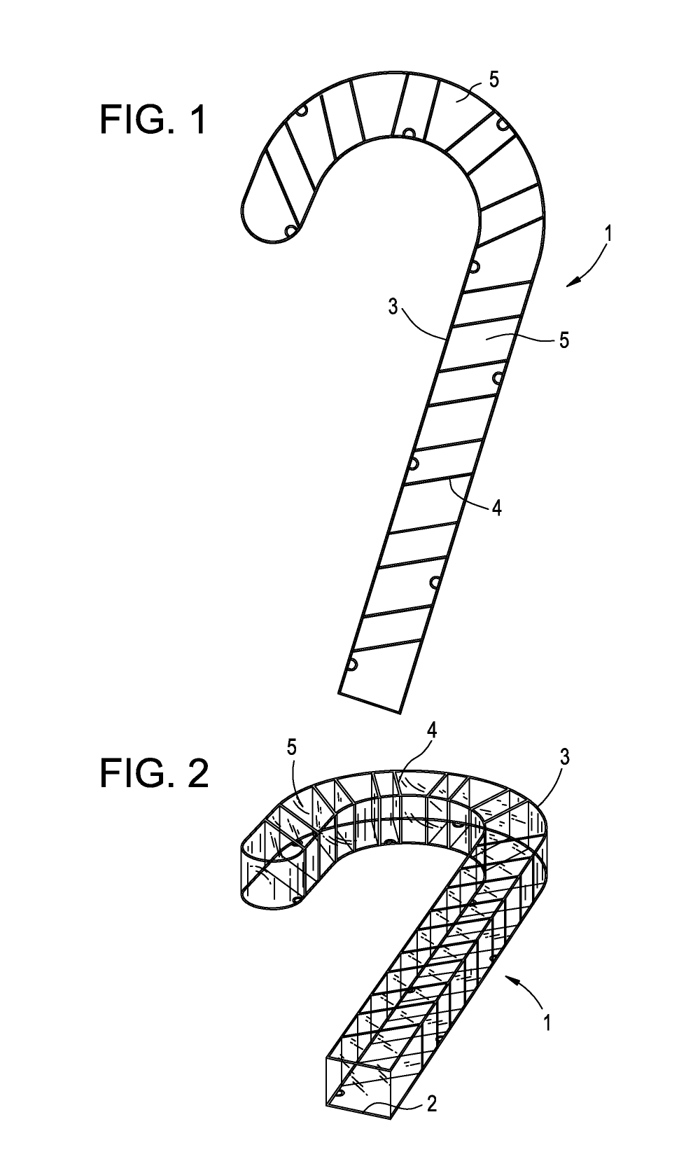

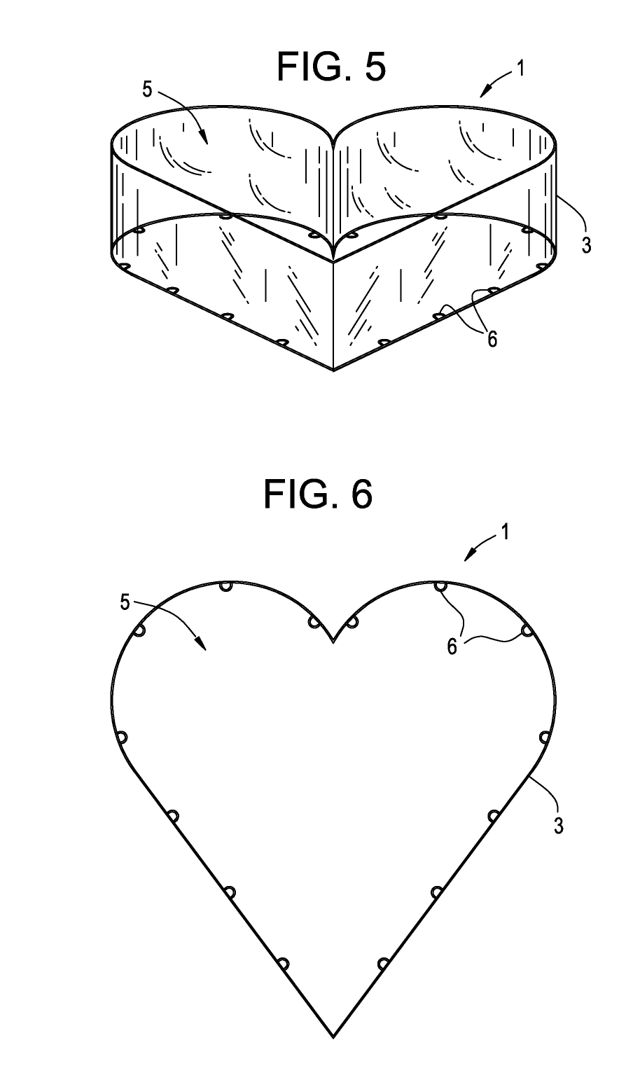

The present invention is directed to a plant shape template. With reference to the drawings, and particularly FIGS. 1 and 2, a version of the plant shape template 1 is made of a bottom section 2 and side sections 3. The bottom section 2 may be open or closed. In one embodiment, the plant shape template 1 has no bottom section at all. The plant shape template 1 further comprises dividers 4 creating defined spaces 5. As noted in FIGS. 5 and 6, a preferred embodiment of the invention comprises anchor means 6 attached to the lower section of the plant template 1.

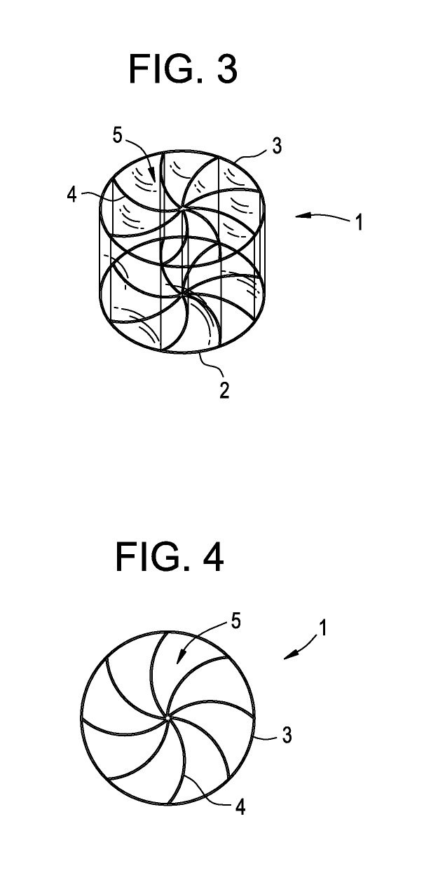

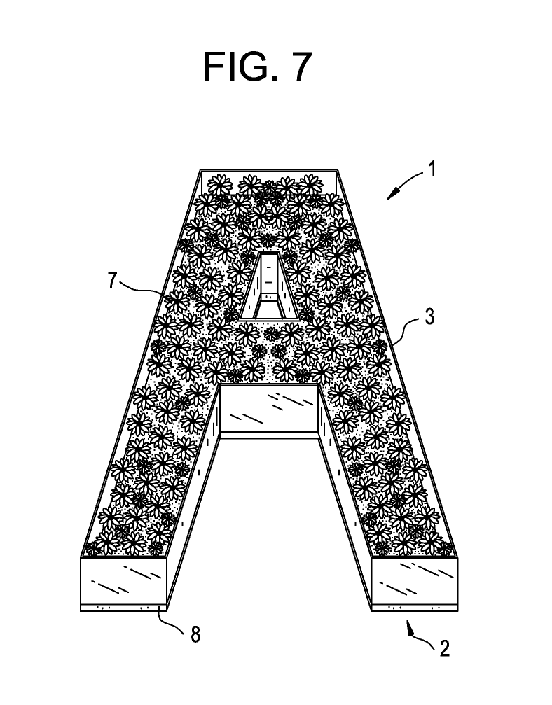

As illustrated in FIGS. 2, 3, 5, and 7, the plant shape template may be comprised of different shapes. The shapes shown in the figures are representations of certain embodiments of the invention. However, it is understood that the invention covers and relates to all plant shapes and designs created by this device and/or method. In one embodiment, the plant shape template 1 is in the shape of holiday decorations, as noted in FIGS. 2 and 3. In another embodiment, the plant shape template 1 is in the shape of number or letters, as shown in FIG. 7. In yet another embodiment, the plant shape template 1 is in the shape of plants or animals. FIGS. 2 and 3 show a candy cane shape and peppermint shape, respectively. Said shapes are not inclusive, and the invention is understood to cover all shapes using any aspect or embodiment of the invention.

In a preferred embodiment, a gardener uses a plant template 1 as shown in FIGS. 2, 3 and 7. The gardener places plants 7 between the dividers 4 into defined spaces 5. In one embodiment, the gardener would alternate the colors of plants placed in each space 5. For example, a gardener may use white plants in the first space 5, red plants in the second space 5, white plants in the third space 5, red plant in the fourth space 5, and so on, forming the shape and color of a candy cane or peppermint, as illustrated in FIG. 2. As shown in FIG. 5, another embodiment of the plant shape template 1 comprising sides 3 configured to form a predetermined shape with a space 5 therein for placing plants. In a preferred embodiment, the plant shape template 1 comprises anchor means 6 for securing plant shape template 1.

As illustrated in FIG. 7, an embodiment of the plant shape template 1 may be in the design of a letter. The plant shape template 1 may include a bottom section 2. Alternatively, the plant shape template 1 may not include a bottom section, and may be open. As shown in FIG. 7, the plant shape template 1 comprises a space 5 for placing plants 7. In a preferred embodiment, the plant shape template 1 comprises a planting material 8 for holding the plants in place. This planting material may be soil, foam, or any other material capable of holding plants.

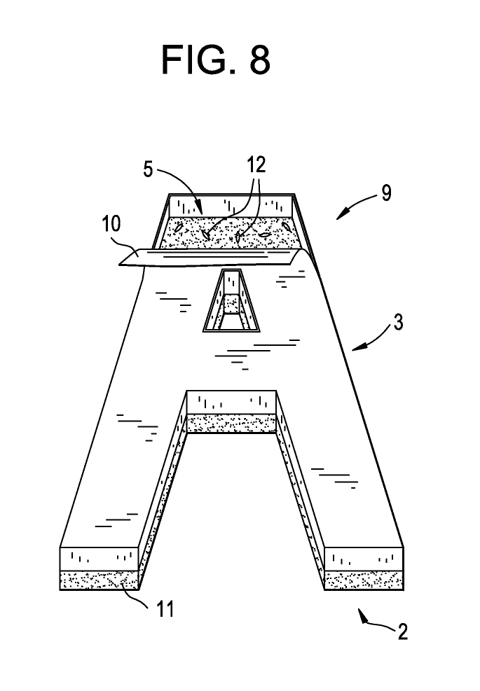

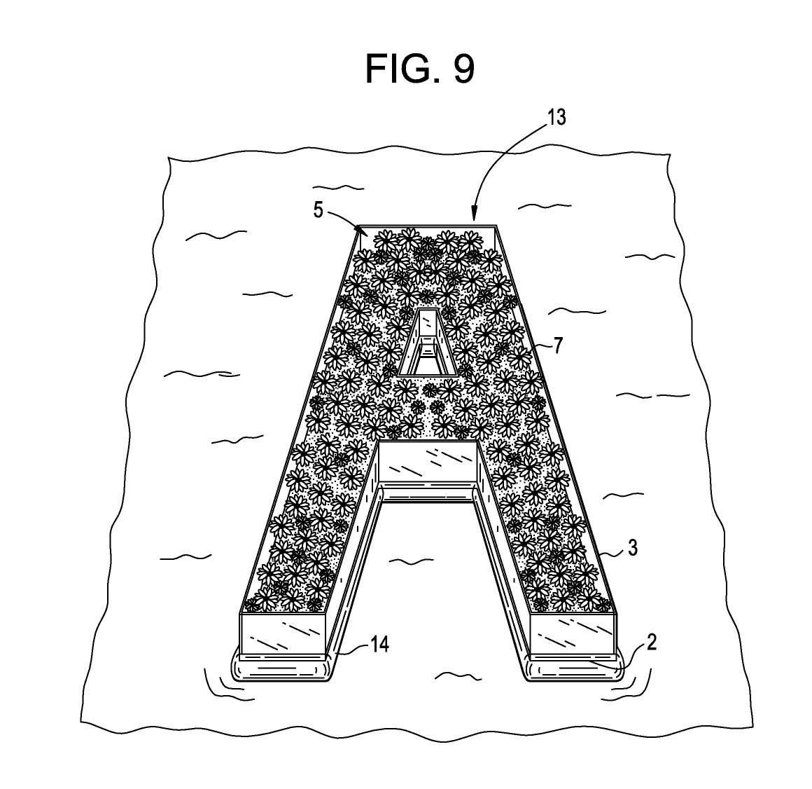

An embodiment of the plant shape template 1 comprises a plant shape template kit 9. As illustrated in FIG. 8, a preferred version of the plant shape template kit 9 comprises a bottom section 2 and side sections 3, forming a space 5 therein. In a preferred embodiment, soil 11 is placed inside the space 5, atop the bottom section 2. The soil 11 comprises seeds 12 therein. The plant shape template kit 9 comprises a removable cover 10. To plant a predesigned plant shape, a user removes the cover 10 from the plant shape template kit 9 and provides water and light. In addition to seeds 12, the plant shape template kit 9 may include seedlings, or more mature plants and/or flowers. The plant shape template may have the plants and/or flowers planted in a predetermined color scheme or design.

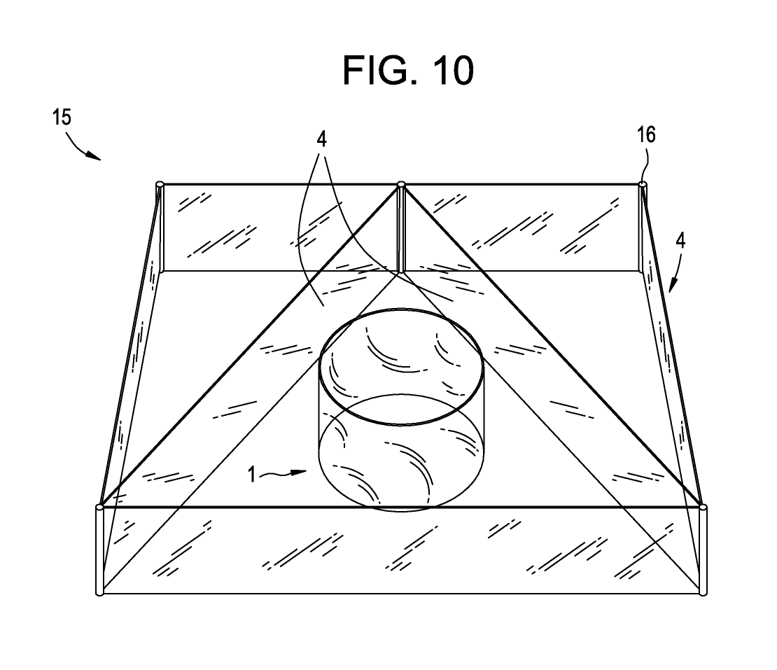

One embodiment of the plant shape template 1 comprises a floating plant shape template 13. As illustrated in FIG. 9, a floating plant shape template 13 comprises a bottom section 2 and sides 3. The bottom section 2 is connected to floatation means 14. The floating plant shape template comprises a space 5 where plants 7 may be placed or planted.

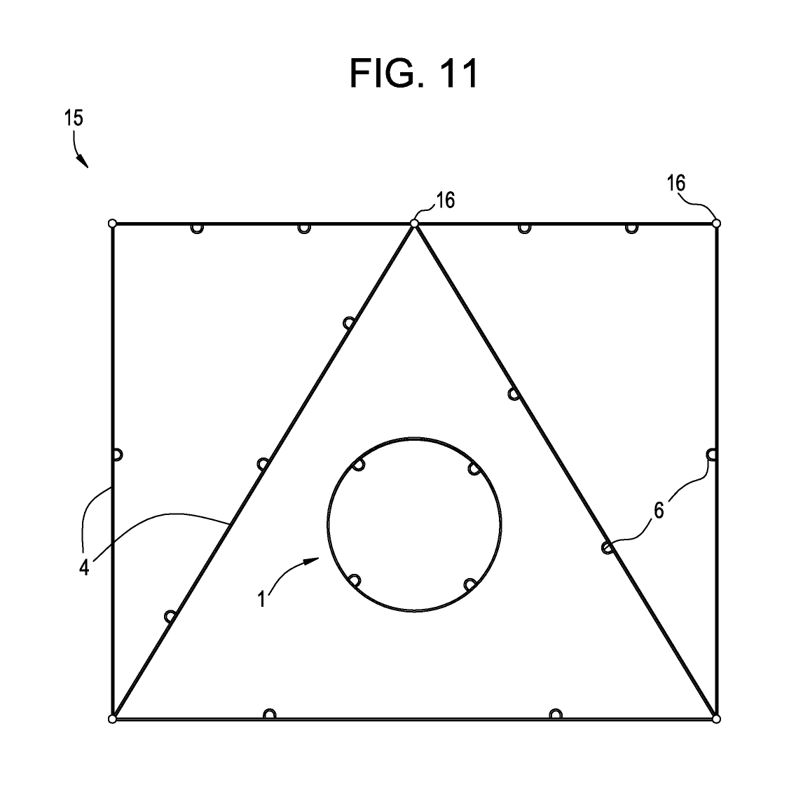

As noted in FIGS. 10 and 11, a gardener may create his own custom design plant template 15. In a preferred embodiment, a gardener may use one or more plant shape templates 1. In addition to using one or more plant shape templates 1, he may use dividers 4 and divider connectors 16. As illustrated in FIGS. 10 and 11, different divider sizes are provided allowing for custom shapes. In a preferred embodiment, as shown in FIGS. 10 and 11, a gardener may use dividers 4, divider connectors 16, and plant shape templates 1, to create a custom design plant template 15. In a preferred embodiment, as in FIG. 11 the dividers 4 and plant shape template 1 have anchors 6 for securing each piece to the ground or other resting place.

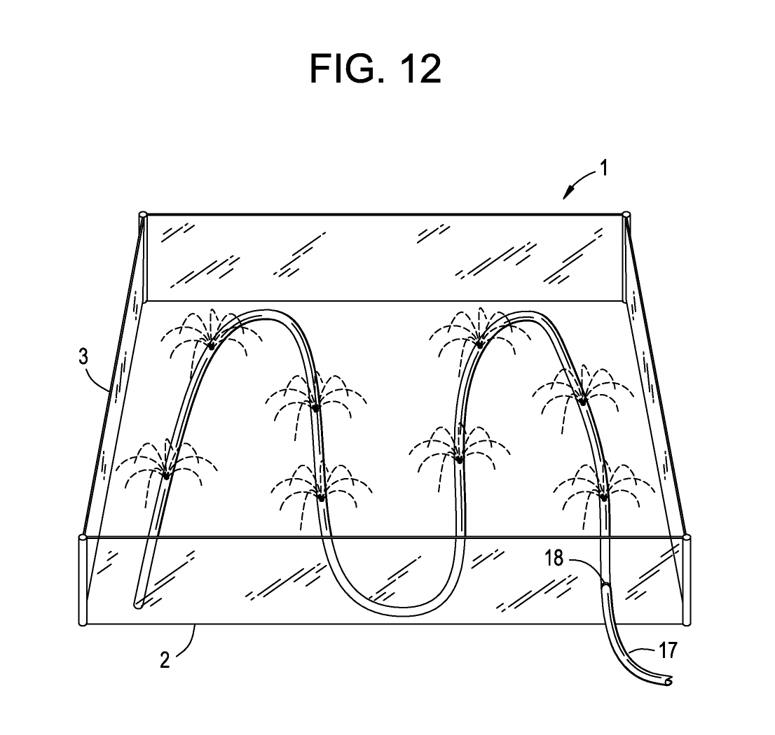

Another embodiment of the present invention includes a watering means for a plant shape template 1. As illustrated in FIG. 12, a hose 17 is incorporated into the plant shape template 1 to provide water directly to the plant base. In one embodiment of the invention, the hose 17 is secured to the bottom section 2 of the plant shape template 1. In yet another embodiment, the hose 17 is attached to the sides 3 of the plant shape template 1. In yet another embodiment, the hose 17 is not attached to the plant shape template at all, but rather is hidden inside the template 1. In yet another embodiment, the hose 17 is inserted into the template by a hole 18 in the at least one side 3.

Additionally, a preferred embodiment of the present invention relates to the method of creating detailed plant shapes using a plant design template 1. The method comprises, first placing the plant template 1 on a support element. In one embodiment, the spaces 5 of plant template 1 are then filled with a medium for holding plants 8. In yet another embodiment, the spaces 5 of plant template 1 do not include a medium for holding plants. The spaces 5 of the plant template are then filled with plants 7.

A version of the invention further comprises the method of creating detailed plant shapes 15 using dividers 4 and divider connectors 16. The dividers 4 and divider connectors 16 may be connected in to form the gardener's desired shape or shapes. In one embodiment, the spaces 5 of the custom design template 15 are filled with a medium for holding plants 8. In yet another embodiment, the spaces 5 of the custom design template 15 do not include a medium for holding plants. The spaces 5 of the custom design template 15 are then filled with plants 7.

What is claimed is:

1. A plant template for creating shapes, letters, and other designs, the apparatus comprising:
a three dimensional shape having a bottom section and a top section,
the bottom section having attachment means for attaching the bottom section to a support element,
the top section being open to the sun and rain.

2. A plant template as in (1), further comprising the top section having a removable cover attached thereto.

3. A plant template as in (1), further comprising the support element is the ground.

4. A plant template as in (1), further comprising the support element is a floatation device.

5. A plant template as in (1), further comprising the support element is a raised platform.

6. A plant template for creating shapes, letters, and other designs, the apparatus comprising:
a three dimensional shape having a flat bottom section and an open top section,
the flat bottom section having a means for attaching the plant template to a support element,
the open top section being open to the sun and rain.

7. A plant template as in (6), further comprising the open top section having a removable cover attached thereto.

8. A plant template as in (6), further comprising the support element being a buoyant material.

9. A plant template for creating shapes, letters, and other designs, the apparatus comprising:
a three dimensional shape having a bottom, a top, and sides,
the shape being separated into defined areas based on a predetermined shape, letter, or design,
the defined areas being filed with different plants to illustrate the plant template design.

10. A plant template as in claim (9), further comprising the bottom side and top side are open.

11. A plant template as in claim (9), further comprising the predetermined shape, letter or design is a letter or number.

12. A plant template as in claim (9), further comprising the predetermined shape is an abstract shape.

13. A plant template as in claim (9), further comprising, the bottom section is secured to a floatation means.

14. A plant template for creating shapes, letters, and other designs, the apparatus comprising:
a three dimensional shape having a bottom section and a top section,
the bottom section being in contact with a buoyant material capable of floatation,
the open top section being open to the sun and rain.

15. A kit for creating plant templates of shapes, letters, and other designs, the kit comprising:
divider pieces of varying lengths for forming the sides of the template, and
divider connector pieces for connecting the divider pieces,
the divider connector pieces capable of attaching up to five divider pieces thereto.

16. A kit for growing plants in a predetermined shape or design, the kit comprising:
a plant template having sides, an open top, and a closed bottom,
dirt with seeds mixed therein resting inside the plant template, atop the plant template bottom,
a removable cover attached to the open top.

17. A kit of claim 16, further comprising, the dirt has plants or flowers pre-planted therein.

18. A method for planting plants in a specific design, the method comprising:
placing the plant template of claim (1) on a support element,
filling the plant template with a material for holding plants, and
inserting plants into the plant template.

19. A method for planting plants in a specific design, the method comprising:
placing the plant template of claim (9) on a support element,
filling the plant template with a material for holding plants, and
inserting plants into the plant template.

20. A method for planting plants in a specific design, the method comprising:
using the kit of claim 16,
creating a predetermined design,
forming the predetermined design with dividers,
connecting the dividers with divider connectors, and
placing plants therein.
